(19) United States
(12) Patent Application Publication
(10) Pub. No.: US 2007/0165154 A1
(43) Pub. Date: Jul. 19, 2007

(54) Display device and method of controlling light therein

(75) Inventors: Leland R. Whitney, St. Paul, MN (US); Kenneth A. Epstein, St. Paul, MN (US); John A. Wheatley, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/334,320

(22) Filed: Jan. 18, 2006

(51) Int. Cl. G02F 1/1335

(52) U.S. Cl. 349/61

(57) ABSTRACT

Disclosed herein is a display device having a back reflector; a display panel; one or more light sources disposed between the back reflector and the display panel; a first layer having first light reflective regions and first light transmissive regions, the first layer disposed between the one or more light sources and the display panel; and a second layer having second light reflective regions and second light transmissive regions, wherein the second layer is disposed spaced apart from the first layer and between the first layer and the display panel; wherein the light source illuminates the display panel through the first and second layers. Also disclosed herein is a method of controlling light within the display device.

### FIELD OF THE INVENTION

The invention relates to a display device such as a liquid crystal display (LCD) device or other similar device. The invention also relates to a method of controlling light within a display device, and more specifically, to a method of controlling the intensity and spatial uniformity of light within a display device.

### BACKGROUND

Display devices generally use one or more light sources to illuminate a display panel. Ideally, a viewer should not be able to discern where the light sources are, no matter where he or she is positioned on the viewing side of the display panel, and the light should appear uniformly distributed across the display panel with no noticeable bright or dim spots.

Diffuser plates disposed between the light sources and the display panel are often used to increase light uniformity. Diffuser plates often comprise a rigid sheet formed from some polymer with diffusing particles or voids distributed throughout. Unfortunately, many problems exist with the use of polymeric diffuser plates. For example, they often deform or warp due to extreme heat and/or light generated inside of display devices such as televisions. They are typically thick and heavy and require a large operating distance inside the display device and so are difficult to incorporate into lightweight and thin handheld devices. In addition, polymeric diffuser plates often absorb light thereby reducing the overall brightness at the display panel.

### BRIEF SUMMARY

Disclosed herein is a display device having a uniformly bright, viewable display, and a method of controlling light within the display device. Examples of display devices are televisions, computer monitors, hand-held devices such as a cell phones, backlit signs, and the like. The display device disclosed herein may be an LCD device having a direct-lit configuration.

An exemplary display device comprises a back reflector; a display panel; one or more light sources disposed between the back reflector and the display panel; a first layer comprising first light reflective regions and first light transmissive regions, the first layer disposed between the one or more light sources and the display panel; and a second layer comprising second light reflective regions and second light transmissive regions, wherein the second layer is disposed spaced apart from the first layer and between the first layer and the display panel; wherein the light source illuminates the display panel through the first and second layers.

Also disclosed herein is a method of controlling light within a display device, the method comprising: providing a back reflector; providing a display panel; providing a light source disposed between the back reflector and the display panel; providing a first layer comprising first light reflective regions and first light transmissive regions, the first layer disposed between the light source and the display panel; providing a second layer comprising second light reflective regions and second light transmissive regions, wherein the second layer is disposed spaced apart from the first layer and between the first layer and the display panel; and causing the light source to illuminate the display panel through the first and second layers.

The above summary is not intended to describe each disclosed embodiment or every implementation of the invention. The Figures and the detailed description which follow more particularly exemplify illustrative embodiments.

### BRIEF DESCRIPTION OF THE DRAWINGS

FIG. 1 shows a schematic cross-sectional view of a display device.

FIG. 2 shows a schematic cross-sectional view of selected components of a display device.

FIG. 3 shows a schematic cross-sectional view of a display device.

FIG. 4 shows a perspective view of a first layer.

FIG. 5a shows a perspective view of the first layer shown in FIG. 4 and a second layer.

FIG. 5b shows a plan view of the first and second layers shown in FIG. 5a.

FIG. 6 shows a perspective view of selected components of a display device, including the first and second layers shown in FIGS. 5a and 5b.

FIG. 7 shows a perspective view of the components shown in FIG. 6 and a diffuser layer.

FIG. 8 shows data from modelling studies carried out on the embodiment shown in FIG. 7.

### DETAILED DESCRIPTION

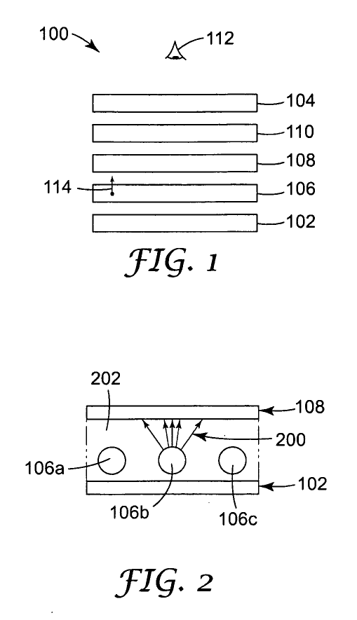

FIG. 1 shows a schematic cross-sectional view of an exemplary display device 100 that includes five principal components. These include back reflector 102, display panel 104, light source 106, first layer 108, and second layer 110. In general, light source 106 emits light, depicted by ray 114 that propagates through first layer 108 and second layer 110 and illuminates display panel 104 making an image or graphic visible for one or more viewers 112 disposed on the opposite side thereof.

Display device 100 and its components are shown in simplified box-like form in FIG. 1, but the reader will understand that each contains additional detail, as described below. Any or all of these components may be positioned generally parallel to each other, and they may have dimensions that are the same or different from each other and/or with display device 100. From the standpoint of a viewer disposed directly in front of the display panel, the other components shown in FIG. 1 are generally not visible. Other configurations, however, may be possible. Gaps between adjacent components are shown for illustration purposes only and may or may not exist depending on the design of the particular display device in which they are used.

Display panel 104 may comprise any type of display that is capable of producing images, graphics, text, etc. In some display devices, images, graphics, text, etc. may be produced from an array of typically thousands or millions of individual picture elements (pixels) that may substantially fill the lateral extent (length and width) of the display panel 104. The array of pixels may be organized in groups of multicolored pixels (such as red/green/blue pixels, red/green/blue/white pixels, and the like) so that the displayed image is polychromatic. The pixels may also be such that the displayed image is monochromatic. In one embodiment, display panel 104 is an LCD panel which typically comprises a layer of liquid crystalline material disposed between two glass plates, and a controller is used to activate selectively the pixels such that the images, graphics, text, etc. are viewable on the side of the display panel opposite light source 106.

Display device 100 may be a backlit sign having a light source that illuminates an imaged transmissive substrate having an image, graphic, text, etc. formed thereon. In this case, display panel 104 comprises the transmissive substrate. Useful transmissive substrates have a transmission of at least about 20 percent and include polymeric films such as polyesters, polyolefins, vinyls, acrylics, polyurethanes, etc., and paper. The transmissive substrate may comprise additional layers coated thereon which may have the image, graphic, text, etc. formed thereon, or which may be used to further diffuse light or provide protection against weathering. 0

In general, light source 106 may comprise any type and/or configuration of light source typically used in display devices. For example, light source 106 may comprise one or more cold cathode fluorescent lamps (CCFLs), hot cathode fluorescent lamps, incandescent lamps, electroluminescent lights, phosphorescent lights, light emitting diodes (LEDs), or combinations thereof. Light emitted by light source 106 may be white, red, green, or blue, for example, or some combination thereof.

Light source 106 may be disposed directly behind the display device in what is known as a direct-lit configuration. When one or more light sources is used, they may be disposed in rows, e.g., along reflective strips of material, or they may be disposed in rings, modules, hexagonal lattice arrays, at random, or some combination thereof. In some cases, the light source may comprise one or more LEDs, such as an array of twenty or hundreds of LEDs. In any case, the number of light sources, the spacing between them, and their placement relative to other components in display device 100 can be selected as desired depending on design criteria such as power budget, thermal considerations, size constraints, cost, and so forth.

FIG. 2 shows a schematic cross-sectional view of selected components of an exemplary display device. Light source 106 comprises a set of three individual light sources 106a, 106b, and 106c, such as the CCFLs described above. Back reflector 102 and first layer 108 form a light recycling cavity 202, within which light, as depicted by rays 200, can undergo successive reflections until it is able to propagate through first layer 108 (as described below). For optimum illumination and efficiency, it is typically advantageous for back reflector 102 to have overall high reflectivity and low absorption.

In one embodiment, back reflector 102 is a specular reflector, for example, the multilayer polymeric films available as Vikuiti™ ESR from 3M Company, and aluminum reflector sheets such as MIRO® products available from Alanod Aluminum-Veredlung GmbH & Co.

In another embodiment, back reflector 102 is a diffuse reflector that at least partially converts the polarization of incident light upon reflection. That is, if light of one polarization state is incident on back reflector 102, then at least a portion of the reflected light is polarized in another polarization state orthogonal to the first state. Examples of suitable diffuse reflectors include polymeric articles comprising polyesters, polycarbonates, polyacrylics, polystryrenes, polyolefins and the like, loaded with diffusely reflective particles such as titanium dioxide, barium sulphate, calcium carbonate and the like. The diffuse reflector may also be a microvoided and/or a microporous article, such as a polymeric article having air-filled voids formed by stretching, or a polymeric article having polymer domains and a diluent formed by thermally induced phase separation. The diffuse reflector may also be a pressed cake or tile of a white inorganic compound such as barium sulfate or magnesium oxide.

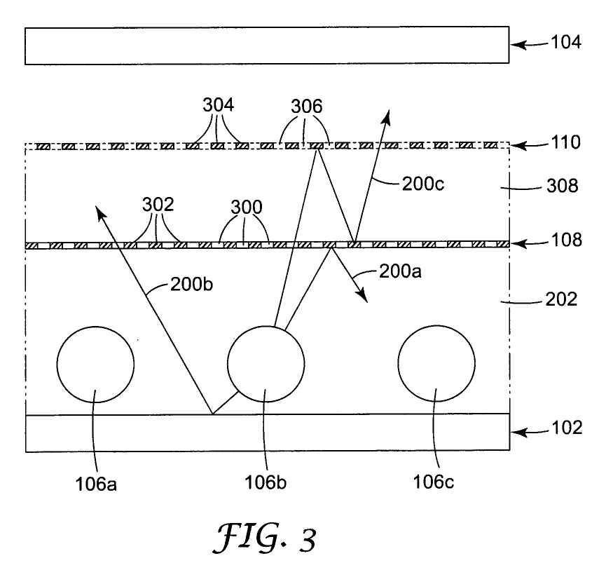

The operating principles behind the method disclosed herein may be partially described using the schematic cross-sectional view of an exemplary display device shown in FIG. 3. Light is emitted by light source 106b, for example, as partially depicted by rays 200. First layer 108 comprises light transmissive regions 300 and light reflective regions 302. Most of the light emitted by light source 106b, as depicted by exemplary ray 200a, and incident upon first layer 108, is either transmitted through one of the light transmissive regions 300 into cavity 308, or it is reflected by one of the light reflective regions 302 back into cavity 202 where it is then recycled. Light directed away from first layer 108, as depicted by exemplary ray 200b, is eventually directed toward it by multiple reflections from back reflector 102 and any other surfaces that make up cavity 202.

Second layer 110 comprises light reflective regions 304 and light transmissive regions 306. Light that enters cavity 308 may be transmitted through one of the light transmissive regions 306, or it may be reflected by one of the light reflective regions 304. In the latter case, light is recycled within cavity 308, as depicted by exemplary ray 200c, until it is eventually transmitted through one of the light transmissive regions 306. Other combinations of transmissions and reflections are also possible.

Light that is transmitted through second layer 110 illuminates display panel 104, either directly or after being transmitted through additional layers (as described below). In either case, the spatial uniformity of the irradiance at the display panel is increased by using the first and second layers in combination. Without first layer 108 and second layer 110, the area of display panel 104 that is closest to light source 106b, for example, receives greater irradiance due to directly incident light, as compared to the rest of the display panel, and thus this area appears brighter when viewed from the opposite side thereof. If only first layer 108 is used, this area of display panel 104 does not necessarily receive less irradiance due to directly incident light. By adding second layer 110 spaced apart from first layer 108, however, the degree to which this area of display panel 104 receives directly incident light may be reduced.

Light that is recycled in either cavity 202 or 308 eventually makes its way to the display panel (assuming high reflectivity) in regions somewhat further away from the light source. Thus, this method of controlling light allows one to increase spatial uniformity of irradiance at the display panel by increasing the length and complexity of the path of light from light source 106 to display panel 104.

The sizes and relative positions of the components shown in FIG. 3 may be varied in order to obtain the desired brightness and uniformity of brightness at the display panel. In many cases, however, the design of the display device may begin with a “fixed” set of parameters related to the light source and the back reflector, which are typically provided as part of a backlight assembly. The number of light sources typically depends on brightness requirements for the display device; for example, a backlit sign may comprise 3 light sources, and a large television may comprise anywhere from 8 to 40 light sources. In one embodiment, the distance between light sources is about 5 to 15 times the size of the light sources. For example, in a large television, the light sources may each be about 2-4 mm in diameter and spaced about 20-40 mm apart. The light sources and the back reflector are typically less than 5 mm apart, depending on the particular backlight assembly being used.

The sizes and shapes of the light transmissive and reflective regions in first layer 108 may be selected as a function of the sizes of the light sources and the spacing between light sources if more than one is used. The size of the spacing between the light sources is visible to the eye such that undesirable optical artifacts introduced by the combined effect of the first and second layers may appear at the display panel. For these artifacts to be invisible to the eye, they must be smaller than the size scales that are visible, therefore, smaller than the distance between light sources, which is visible. Thus, in one embodiment, the distance between light sources is greater than the sizes of the first light reflective regions and the first light transmissive regions.

The sizes of the light transmissive and reflective regions in first layer 108, relative to each other, may also be varied. If the size of light transmissive regions 300 is too small, then the efficiency of the overall display device may be adversely impacted, because a very large number of reflections would be required for most of the light to reach the display panel. If the size of light reflective regions 302 is too small, too much light having the shortest direct paths to the display panel would be transmitted, and first layer 108 would become just another clear layer. Thus, in many cases, it is useful for the sizes of the light transmissive and reflective regions in the first layer to be comparable, at least within an order of magnitude. In one embodiment, for a display device having an LCD display panel, it is useful for the sizes to be up to about 10 times the pixel size. For example, for a pixel size of 0.5 mm, the sizes of the light transmissive and reflective regions in first layer 108 may be up to about 5 mm.

First layer 108 may be positioned relative to the light sources such that the desired amount of light having the shortest direct paths to the display panel is reflected, as determined by the spatial uniformity required at the display panel, and at the same time, enough of the light is transmitted into cavity 308 so that the desired brightness may be obtained.

The distance between first layer 108 and back reflector 102 may also be varied. If more than one light source is used, it may be desirable to minimize the ratio of the distance between light sources to the distance between first layer 108 and back reflector 102. In this case, a good starting point is to position first layer 108 at twice the distance between light sources. The size of the light source may also be considered. For example, for a light source about 2-4 mm, the distance between first layer 108 and back reflector 102 may be from about 10 to about 15 mm. The backlight assembly, however, may dictate how small this distance may be; for example, it may have side walls that limit how close first layer 108 may be disposed relative to back reflector 102.

The thickness of first layer 108 may also be varied. For example, if first layer 108 is Vikuiti™ ESR from 3M Company, then the thickness may be about 100 microns (4 mil). If first layer 108 is a coating on a transmissive slab (as described below), then the thickness may be on the order of a few Angstroms.

FIG. 4 shows a perspective view of an exemplary first layer 400 comprising first light transmissive regions 402 and first light reflective regions 404. The first light transmissive regions are shaped as circles that are spaced equidistant from each other. The first light reflective regions comprise the contiguous area surrounding the first light transmissive regions.

In general, first layer 108 may be some variation of exemplary first layer 400. For example, first light transmissive regions may comprise a first shape, wherein the first shape comprises a circle, rectangle, star, trapezoid, triangle, square, ellipse, hexagon, polygon, or a combination thereof. First light transmissive regions may be spaced apart from each other in any configuration across the first layer; for example, uniformly spaced apart in one or two directions. First light transmissive regions may have the same or different shapes, and/or the same or different sizes. Factors to consider are the shape or combination of shapes being used, the dimensions of the light source, the overall performance requirements, etc. For example, when the one or more light sources is one or more LEDs, the first light transmissive regions may have a first shape comprising a circle. For another example, when the one or more light sources is one or more fluorescent tubes, the first light transmissive regions may have a first shape comprising a rectangle. The total area of the first light transmissive regions may comprise at least about 20 to about 80% of the total area of the first layer.

The sizes of the light transmissive and reflective regions in second layer 110 may be varied depending on the sizes of the regions in first layer 108, and they also may be varied relative to each other. If the size of second light transmissive regions 306 is too small, then the efficiency of the overall display device may be adversely impacted, because a very large number of reflections would be required for most of the light to reach the display panel. If the size of second light reflective regions 304 is too small, too much light having the shortest direct paths to the display panel would be transmitted, and second layer 110 would become just another clear layer. Thus, in many cases, it is useful for the sizes of the first light transmissive regions, the first light reflective regions, the second light transmissive regions, and the second light reflective regions to be within an order of magnitude. In one embodiment, the display device may comprise three light sources, each about 3 mm in diameter and spaced about 30 mm apart, and the sizes of the light transmissive and reflective regions in first layer 108 and second layer 110, respectively, are about 0.1 mm.

The second light reflective regions may be smaller or larger than the first light transmissive regions. For example, the relative sizes may be adjusted so that a 40% on-axis transmission and a 60% off-axis transmission of light may be obtained.

The second light reflective regions may be registered with the first light transmissive regions, although this is not required, as long as the desired spatial uniformity is obtained.

The distance between the first and second layers may be within an order of magnitude of the spacing between light sources. For example, the distance may be less than about 30 mm.

The thickness of second layer 110 may also be varied. For example, if second layer 110 is Vikuiti™ ESR from 3M Company, then the thickness may be about 100 microns (4 mil). If second layer 110 is a coating on a transmissive slab (as described below), then the thickness may be on the order of a few Angstroms.

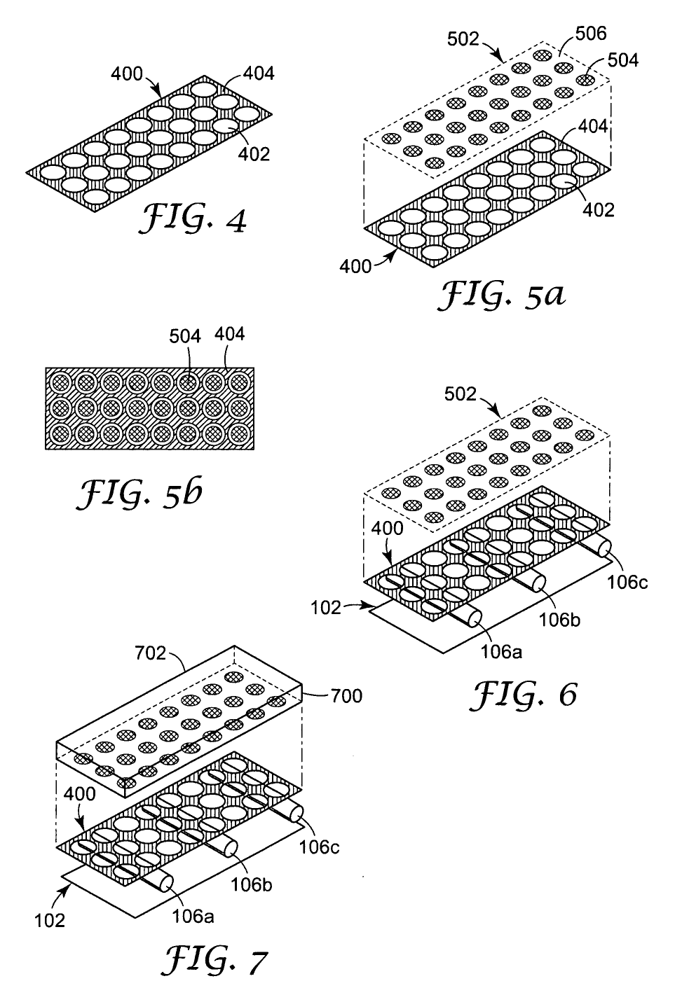

FIG. 5a shows a perspective view of an exemplary second layer 502 and exemplary first layer 400. Exemplary second layer 502 is represented as a layer bounded by dotted lines and comprises second light reflective regions 504 and second light transmissive region 506. The second light reflective regions are shaped as circles which are spaced equidistant from each other. Second light transmissive region 506 comprises the contiguous area surrounding the second light reflective regions. FIG. 5b shows a plan view of the first and second layers described in FIG. 5a. In FIG. 5b, light reflective regions 504 are registered with light transmissive regions 506 such that each pair of registered circles and holes looks like a circle within a circle in a concentric configuration.

In general, second layer 110 may be some variation of exemplary second layer 502. For example, second light reflective regions may comprise a second shape, wherein the second shape comprises a circle, rectangle, star, trapezoid, triangle, square, ellipse, hexagon, polygon, or a combination thereof. Second light reflective regions may be spaced apart from each other in any configuration across the second layer; for example, uniformly spaced apart in one or two directions. Second light reflective regions may have the same or different shapes, and/or the same or different sizes. Factors to consider are the shape or combination of shapes being used, the dimensions of the light source, the overall performance requirements, etc. The total area of the second light reflective regions may comprise at least about 20 to about 80% of the total area of the second layer.

The shapes used in the first layer may be the same or different as those in the first layer. For example, the first light transmissive regions may have the same shape as the second light reflective regions, as shown in FIG. 5. Another useful shape combination is where the first light transmissive regions are circles, and the second light reflective regions are stars.

FIG. 6 shows a perspective view of selected components of an exemplary display device, including the first and second layers shown in FIGS. 5a and 5b. (FIG. 6 is not to scale.) Underneath the first layer is positioned back reflector 102 with a set of light sources 106 disposed in between. In this particular example, the one or more light sources are one or more fluorescent lamps, and the first light transmissive regions and the second light reflective regions are shaped as circles. In another particular example, the one or more light sources is one or more fluorescent lamps, and the first light transmissive regions and the second light reflective regions are shaped as rectangles. Yet another particular example is one in which the one or more light sources are one or more LEDs, and the first light transmissive regions and the second light reflective regions are shaped as circles.

First layer 108 and/or second layer 110 may be free standing layers such as a sheets, films, or plates, and they may be rigid or have some flexibility. Preferably, first layer 108 and second layer 110 are rigid plates. First layer 108 and/or second layer 110 may also be coatings disposed on a transmissive slab. For example, in FIG. 7, the light reflective regions of the second layer are coated on transmissive slab 700. (FIG. 7 is not to scale). The transmissive slab may also be disposed between the first and second layers. The slab may be a free standing layer such as a sheet, film, or plate, and it may be rigid or have some flexibility. Combinations of these layer types and configurations may also be used.

Additionally, first layer 108 and second layer 110 may or may not be coextensive with the area of display panel 104. For example, first layer 108 and second layer 110 may be disposed such that they are associated with a single light source or a group of light sources.

First layer 108 and/or second layer 110 may each comprise one or more layers. For example, first layer 108 and/or second layer 110 may each comprise a single layer or coating of some material having the same reflectivity on both sides. For another example, first layer 108 and/or second layer 110 may each comprise two layers or coatings of two different materials, each having the same or different reflectivity. Also, first layer 108 and/or second layer 110 may each comprise three layers wherein one or both of the outer layers provide the same or different reflectivity. Combinations of these layer configurations may also be used. In one embodiment, at least one of the four sides of the first and second layers is a specular reflector, and at least one other is a diffuse reflector.

The particular materials used to form the first and second layers may be selected so as to provide a selected amount of transmission and or reflection of light. The first and second light transmissive regions may provide greater than about 80%, for example, greater than about 95% transmission. The first and second light reflective regions may provide greater than about 80%, for example, greater than about 95% reflection.

The first and second layers may be prepared using a variety of methods. For example, for exemplary first layer 400, the first light transmissive regions may be punched, die cut, or laser cut into a sheet of reflective material, for example, a highly reflective material such as Vikuiti™ ESR film from 3M Company. This sheet could then be laminated to a transmissive slab. For another example, for exemplary second layer 502, the second light reflective regions may be coated onto the slab by ink jetting, painting, screen printing, or spraying or sputtering on through a mask some reflective material, or they may be reflective stickers adhered to the slab.

Materials used to form first layer 108, second layer 110, and the slab described above are not particularly limited and may be polymers, glasses, metals, ceramics, etc., or combinations thereof. Polymers include any type of polymer that may be prepared via condensation polymerization such as polyesters, polyamides, polyurethanes, polycarbonates, and polyureas; or they may be prepared via addition polymerization such as polyolefins, polyacrylics, polystyrenes, and the like. Incorporation of voids, particles, pores, etc. into polymer may also be used.

Preferably, the display device disclosed herein further comprises a diffuser layer. The diffuser may be disposed between the second layer 110 and the display panel 104. For example, the diffuser layer could be the transmissive slab 700 shown in FIG. 7. The diffuser layer may also be the transmissive slab between first and second layers as described above. The display device may also comprise a reflective polarizer, an absorbing polarizer, a brightness enhancing film, or a combination thereof.

Also disclosed herein is a method of controlling light within a display device, the method comprising: providing a back reflector; providing a display panel; providing a light source disposed between the back reflector and the display panel; providing a first layer comprising first light reflective regions and first light transmissive regions, the first layer disposed between the light source and the display panel; providing a second layer comprising second light reflective regions and second light transmissive regions, wherein the second layer is disposed spaced apart from the first layer and between the first layer and the display panel; and causing the light source to illuminate the display panel through the first and second layers. The method may further comprise adjusting the relative positions of the first and second layers, thereby controlling the intensity and spatial uniformity of light emitted by the light source and incident upon the display panel, so that a desired degree of spatial uniformity is obtained.

When the method of controlling light is used in a display device, the spatial uniformity of light emitted by the one or more light sources and incident upon the display panel is greater in the presence of both the first and second layers, as compared to either the first or second layer alone. Thus, for a predetermined amount of spatial uniformity of light emitted by the light source and incident upon the display panel, the distance between the light source and the display panel may be less in the presence of both the first and second layers, as compared to either the first or second layer alone.

### EXAMPLE

Modelling studies were carried out on the embodiment shown in FIG. 7. The studies were carried out using the optical modelling program ASAP™, available from Breault Research Organization of Tucson, Ariz., and the parameters shown in Table 1. The diffuser layer was modelled as a Henyey-Greenstein volume diffuser having 2 mm thickness, g=0.82, f=1/0.23, host index=1.5+0.0000002i, +/−degree normally oriented source, absorption=4.93%, and transmission=50.4%. Mirrored sides were used to simulate infinite boundary conditions. The diameter of the second light reflective regions in the second layer was varied in order to show how the spatial uniformity of light changes as a function thereof.

TABLE 1

| Parameter | Value | |
|---|---|---|
| diameter of first light transmissive regions¹ | 2 | mm |
| diameter of second light reflective regions¹ | 0.4, 0.8, 1.2, 1.6, | |
| | and 2.0 mm | |
| distance between first and second layers | 1 | mm |
| distance between first layer and back reflector | 15 | mm |
| thickness of diffuser layer | 2 | mm |
| diameter of light sources | 3 | mm |
| distance between light sources² | 30 | mm |
| distance between first light transmissive regions² | 2 | mm |
| distance between second light reflective regions² | 2 | mm |

| | |
|---|---|
| transmissivity of first light transmissive regions | 100% |
| absorptivity of second light reflective regions | 100% |

¹The first and second layers were modelled with infinite thinness.
²The distance is center to center.

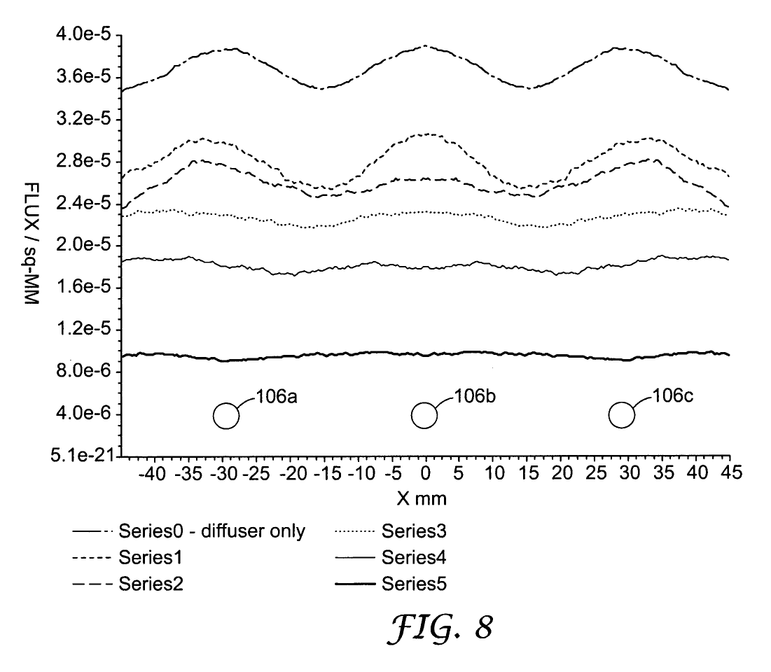

FIG. 8 shows data from the modelling studies wherein the x-axis corresponds to the direction perpendicular to the light sources, and the y-axis corresponds to the average irradiance taken along an infinite length of the light sources. Irradiance was measured at a distance of 2 mm above the second layer, which is the top surface 702 of the diffuser layer 700. Series 0 are data for the model without the first and second layers (diffuser layer 700 only), and Series 1-5 include the first and second layers, with the diameter of the second light reflective regions varied at 0.4, 0.8, 1.2, 1.6, 2 mm, respectively. A merit function is defined and presented in Table 2.

The sizes of the first light transmissive regions and the second light reflective regions may be selected such that the best compromise between uniformity of brightness and overall brightness are obtained.

TABLE 2

| | Diameter of the Second | | |
|---|---|---|---|
| | Light Reflective Regions | Merit Function = | Total |
| Series | (mm) | (Lₘₐₓ − Lₘᵢₙ)/mean | Transmission |
| 0 (control) | 0 | 0.04 | 0.3 |
| 1 | 0.4 | 0.08 | 0.23 |
| 2 | 0.8 | 0.03 | 0.21 |
| 3 | 1.2 | 0.02 | 0.18 |
| 4 | 1.6 | 0.03 | 0.15 |
| 5 | 2.0 | 0.04 | 0.08 |

Various modifications and alterations of this invention will be apparent to those skilled in the art without departing from the scope and spirit of the invention, and it should be understood that this invention is not limited to the examples and embodiments described herein.

What is claimed is:

1. A display device comprising:
a back reflector;
a display panel;
one or more light sources disposed between the back reflector and the display panel;
a first layer comprising first light reflective regions and first light transmissive regions, the first layer disposed between the one or more light sources and the display panel; and
a second layer comprising second light reflective regions and second light transmissive regions, wherein the second layer is disposed spaced apart from the first layer and between the first layer and the display panel;
wherein the light source illuminates the display panel through the first and second layers.

2. The display device of claim 1, wherein the display panel comprises a liquid crystal display panel.

3. The display device of claim 1, wherein the display panel comprises an imaged transmissive substrate having a transmission of at least about 20 percent, and wherein the transmissive substrate is a polymeric film or paper.

4. The display device of claim 1, wherein the one or more light sources comprises one or more cold cathode fluorescent lamps.

5. The display device of claim 1, wherein the one or more light sources comprises one or more light emitting diodes.

6. The display device of claim 1, wherein the one or more light sources is disposed directly behind the display panel.

7. The display device of claim 1, wherein the back reflector comprises a specular reflector or a diffuse reflector.

8. The display device of claim 1, wherein the one or more light sources comprises at least two light sources, and the distance between the at least two light sources is about 5 to 15 times the sizes of the light sources.

9. The display device of claim 1, wherein the one or more light sources comprises at least two light sources, and the distance between the at least two light sources is greater than the sizes of the first light reflective regions and the first light transmissive regions.

10. The display device of claim 1, wherein the sizes of the first light transmissive regions and the first light reflective regions are within an order of magnitude.

11. The display device of claim 10, wherein the display panel is an LCD panel having a pixel size, and the sizes of the first light transmissive regions and the first light reflective regions are up to about 10 times the pixel size.

12. The display device of claim 1, wherein the first light transmissive regions comprise a first shape, wherein the first shape comprises a circle, rectangle, star, trapezoid, triangle, square, ellipse, hexagon, polygon, or a combination thereof.

13. The display device of claim 1, wherein the total area of the first light transmissive regions comprises from about 20 to about 80% of the total area of the first layer.

14. The display device of claim 1, wherein the sizes of the first light transmissive regions, the first light reflective regions, the second light transmissive regions, and the second light reflective regions are within an order of magnitude.

15. The display device of claim 1, wherein the size of the second light reflective regions is less than the size of the first light transmissive regions.

16. The display device of claim 1, wherein the size of the second light reflective regions is greater than the size of the first light transmissive regions.

17. The display device of claim 1, wherein the second light reflective regions are registered with the first light transmissive regions.

18. The display device of claim 1, wherein the distance between the first and second layers is less than about 30 mm.

19. The display device of claim 1, wherein the second light reflective regions comprise a second shape, wherein the second shape comprises a circle, rectangle, star, trapezoid, triangle, square, ellipse, hexagon, polygon, or a combination thereof.

20. The display device of claim 1, wherein the total area of the second light reflective regions comprises from about 20 to about 80% of the total area of the second layer.

21. The display device of claim 1, wherein the first light transmissive regions and the second light reflective regions have the same shape.

22. The display device of claim 1, wherein the first light transmissive regions are spaced equidistant from each other in the first layer, and the second light reflective regions are spaced equidistant from each other in the second layer.

23. The display device of claim 1, wherein the one or more light sources are one or more fluorescent lamps, and the first light transmissive regions and the second light reflective regions are shaped as circles.

24. The display device of claim 1, wherein the one or more light sources are one or more fluorescent lamps, and the first light transmissive regions and the second light reflective regions are shaped as rectangles.

25. The display device of claim 1, wherein the one or more light sources are one or more light emitting diodes, and the first light transmissive regions and the second light reflective regions are shaped as circles.

26. The display device of claim 1, wherein the first and second light transmissive regions provide greater than about 80% transmission.

27. The display device of claim 1, wherein the first and second light transmissive regions provide greater than about 95% transmission.

28. The display device of claim 1, wherein the first and second light reflective regions provide greater than about 80% reflection.

29. The display device of claim 1, wherein the first and second light reflective regions provide greater than about 95% reflection.

30. The display device of claim 1, further comprising a diffuser layer.

31. The display device of claim 1, further comprising a reflective polarizer, an absorbing polarizer, a brightness enhancing film, or a combination thereof.

32. The display device of claim 1, wherein the spatial uniformity of light emitted by the one or more light sources and incident upon the display panel is greater in the presence of both the first and second layers, as compared to either the first or second layer alone.

33. The display device of claim 1 having a predetermined amount of spatial uniformity of light emitted by the light source and incident upon the display panel, wherein the distance between the light source and the display panel is less in the presence of both the first and second layers, as compared to either the first or second layer alone.

34. A method of controlling light within a display device, the method comprising:
providing a back reflector;
providing a display panel;
providing a light source disposed between the back reflector and the display panel;
providing a first layer comprising first light reflective regions and first light transmissive regions, the first layer disposed between the light source and the display panel;
providing a second layer comprising second light reflective regions and second light transmissive regions, wherein the second layer is disposed spaced apart from the first layer and between the first layer and the display panel; and
causing the light source to illuminate the display panel through the first and second layers.

35. The method of claim 34, further comprising:
adjusting the relative positions of the first and second layers, thereby controlling the intensity and spatial uniformity of light emitted by the light source and incident upon the display panel.
